(19) United States
(12) Patent Application Publication
(10) Pub. No.: US 2015/0106879 A1
(43) Pub. Date: Apr. 16, 2015

(54) DATA RECOVERY METHOD, DEVICE AND SYSTEM USING SAME

(71) Applicant: Tencent Technology (Shenzhen) Company Limited, Guangdong (CN)

(72) Inventors: Xiaomu Wen, Guangdong (CN); Yu Chen, Guangdong (CN); Jingzhong Li, Guangdong (CN); Bin Li, Guangdong (CN)

(73) Assignee: Tencent Technology (Shenzhen) Company Limited

(21) Appl. No.: 14/576,685

(22) Filed: Dec. 19, 2014

Related U.S. Application Data
(63) Continuation of application No. PCT/CN2014/076789, filed on May 5, 2014.

(30) Foreign Application Priority Data
May 31, 2013 (CN) 201310213202.X

(51) Int. Cl. H04L 29/06; G06F 21/31

(52) U.S. Cl. CPC H04L 63/08; G06F 21/31
USPC 726/3

(57) ABSTRACT

The present disclosure relates to a filed of data processing technology. Disclosed are a data recovery method, a device and a system using the same. The data recovery method includes the following steps. A second client receives an identifying account associating with a first account and sends the identifying account to a server. The server receives the identifying account and sends a data recovery linkage to a verifying client. The verifying client responses to a connection request of the data recovery linkage and sends a data recovery confirming message to the server. The server receives the data recovery confirming message and copies the data stored in the first client to the second client according to the data recovery confirming message. The embodiments of present disclosure may recovery the data stored in the first client via the identifying account associating with the first account, when the first account is lost.

### CROSS-REFERENCE TO RELATED APPLICATIONS

This is a U.S. continuation application under 35 U.S.C. §111(a) claiming priority under 35 U.S.C. §§120 and 365(c) to International Application No. PCT/CN2014/076789 filed on May 5, 2014, which claims the priority benefit of Chinese Patent Application NO. 201310213202.X filed on May 31, 2013, the contents of which are incorporated by reference herein in their entirety for all intended purposes.

### FIELD OF THE TECHNICAL

The present disclosure relates to a field of data processing technology, and specifically to a data recovery method, a device and a system using the same.

### BACKGROUND

With a development of technology, daily life becomes much more convenient. When people browse webpage, they may find some pictures and music which they like. Usually, they login network storage space by using an account and store the pictures and music they like into the network storage space.

However, when people login the network storage space, the account according to the network storage space is needed. If the account is lost, data stored in the network storage space can not be recovered.

### SUMMARY

A data recovery method, a system and a device using the same are provided in the following embodiments of present disclosure. The data recovery method, the system, and the device can solve the problems that in the current technology.

According to a first aspect of the invention, a data recovery method is provided in one exemplary embodiment of present disclosure. The data recovery method includes the following steps.

A second client receives the identifying account associating with the first account and sends the identifying account to the server. Hereinto, the second client is a client which the user logins via the second account. The first account and the second account are accounts registered in a same application.

The server receives the identifying account and sends a data recovery linkage to the verifying client. Hereinto, the verifying client is a software client which may be logged in by the user via the identifying account.

The verifying client responses to a connection request of the data recovery linkage, and sends a data recovery confirming message to the server.

The server receives the data recovery confirming message and copies the data stored in the first client to the second client according to the data recovery confirming message. Hereinto, the first client is a client which may be logged in by the user via the first account.

According to the second aspect of the invention, a data recovery method is provided in another exemplary embodiment of present disclosure. The data recovery method includes the following steps.

Receiving an identifying account associating with a first account sent by the second client, and sending a data recovery linkage to a verifying client, and determining whether response to the data recovery linkage according to a selection input by the user via the verifying client. Hereinto, the second client is a client which may be logged in by the user via the second account. The verifying account is a software client which may be logged in by the user via the identifying account. The first account and the second account are accounts registered in a same application.

Receiving a data recovery confirming message sent from the verifying client, and copying the data stored in the first client to the second client according to the data recovery confirming message. Hereinto, the first client is a client which may be logged in by the user via the first account.

According to the second aspect of the invention, a data recovery device is provided in yet another exemplary embodiment of present disclosure. The device includes the following modules.

Data recovery linkage sending module, which is configured to receive an identifying account associating with a first account sent by the second client, and sending a data recovery linkage to a verifying client, and determining whether response to the data recovery linkage according to a selection input by the user via the verifying client. Hereinto, the second client is a client which may be logged in by the user via the second account. The verifying account is a software client which may be logged in by the user via the identifying account. The first account and the second account are accounts registered in a same application.

Data copying module 502, which is configured to receive a data recovery confirming message sent from the verifying client, and copy the data stored in the first client to the second client according to the data recovery confirming message after the data recovery linkage sending module 501 sends the data recovery linkage. Hereinto, the first client is a client which may be logged in by the user via the first account.

According to the fourth aspect of the invention, a data recovery system is provided in yet another exemplary embodiment of present disclosure. The data recovery system includes the following devices.

A second client, which is configured to receive an identifying account associating with the first account and send the identify account to the server. Hereinto, the second client is a client which the user logins via the second account. The first account and the second account are accounts registered in a same application.

A server, which is configured to receive the identifying account, send a data recovery linkage to the verifying client 3, receive a data recovery confirming message sent from the verifying client, and copy the data stored in the first client to the second client 1 according to the data recovery confirming message.

A verifying client which is configured to response to a connection request of the data recovery linkage sent from the server and sends a data recovery confirming message to the server.

In the embodiment of present disclosure, the second client sends the identify account associating with the first account to the server. The server sends data recovery linkage to the verifying client. The verifying client sends data recovery confirming message to the server. And the server copies the data stored in the first client to the second client. Thus, even if the first account is lost, the user may recovery the data stored in the first client via the identifying account associating with the first account.

### BRIEF DESCRIPTION OF THE DRAWINGS

In order to make embodiments of present disclosure more clearly, the drawings which are needed in the embodiments of present disclosure are described simply as follows. It is obviously, the drawings described as the follows are only exemplary embodiments of present disclosure. To a person of ordinary skill in the art, under premise of no creative work, other drawings may be obtained according to the drawings.

FIG. 1 is a flow chart of a data recovery method according to one embodiment of present disclosure.

FIG. 2 is a flow chart of a data recovery method according to one embodiment of a detailed application of present disclosure.

FIG. 3 is a flow chart of a data recovery method according another embodiment of present disclosure.

FIG. 4 is a schematic block diagram of a data recovery system according to one embodiment of present disclosure.

FIG. 5 is a schematic block diagram of a data recovery device according to one embodiment of present disclosure.

### DETAILED DESCRIPTION OF ILLUSTRATED EMBODIMENTS

Further description of present disclosure will be illustrated clearly and completely, which combined with embodiments in drawings and detailed embodiment. Obviously, the embodiments here are not all the embodiments but only part of the embodiments of present disclosure. Based on the embodiments of present disclosure, under premise of without paying out creative work, other embodiments obtained by the person having ordinary skill in the art are considered to be encompassed within the scope of the present invention.

In the embodiment of present disclosure, a second client sends an identifying account associating with a first account to a server. The server sends a data recovery linkage to a verifying client. The verifying client sends a data recovery confirming message to the server. And the server copies the data stored in a first client to the second client. Thus, when the first account is lost, the user may recovery the data stored in the first client via the identifying account associating with the first account.

Further description of present disclosure will be illustrated clearly and completely, which is combined with detailed embodiments.

### A First Embodiment

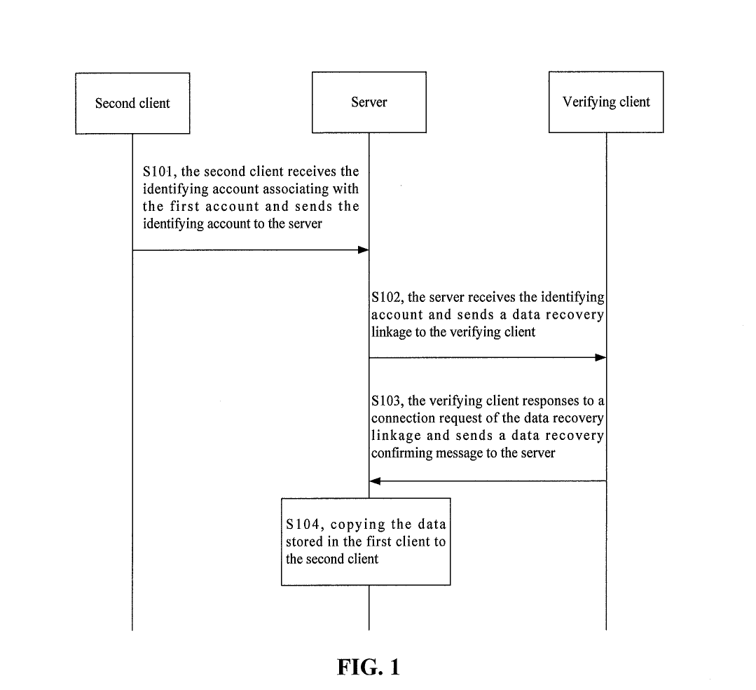

Referring to FIG. 1, FIG. 1 is a flow chart of a data recovery method according to one embodiment of present disclosure. The data recovery method includes the following steps.

Step S101, the second client receives the identifying account associating with the first account and sends the identifying account to the server. Hereinto, the second client is a client which the user logins via the second account. The first account and the second account are accounts registered in a same application.

In the embodiment of present disclosure, the user logins the second client and inputs the identifying account associating with the first account. The second client is a software client which may be logged in by the user via the second account. The first account and the second account are accounts registered in a same application. It is important to point that the application may be variety of communication applications, such as e-mail address, instant massaging (IM) application, and microblog etc. The user may login the second client via the software client installed in a terminal, and the user may also login the second client via webpage. When the second client receives the identifying account input by the user, the second client sends the identifying account associating with the first account to the server.

Step S102, the server receives the identifying account and sends a data recovery linkage to the verifying client. Hereinto, the verifying client is a software client which may be logged in by the user via the identifying account.

In the embodiment of present disclosure, when the server receives the identifying account sent by the second client, the server sends the data recovery linkage to the verifying client. When the user logins the verifying client, clicking the data recovery linkage to make sure that the data stored in the first client is copied to the second client.

Step 103, the verifying client responses to a connection request of the data recovery linkage and sends a data recovery confirming message to the server.

In the embodiment of present disclosure, the verifying client receives a click of data recovery linkage via the verifying client by the user, responses the connection request of the data recovery linkage, receives the click of data recovery linkage via the verifying client by the user, and sends data recovery confirming message to the server.

Step S104, the server receives the data recovery confirming message and copies the data stored in the first client to the second client according to the data recovery confirming message. Hereinto, the first client is a client which may be logged in by the user via the first account.

In the embodiment of present disclosure, the data includes address books, videos, documents, audios, pictures and etc. When the server receives the data recovery confirming message fed back from the verifying client, the server copies the data stored in the first client to the second client.

In the embodiment of present disclosure, the second client sends the identify account associating with the first account to the server. The server sends data recovery linkage to the verifying client, the verifying client sends data recovery confirming message to the server, and the server copies the data stored in the first client to the second client. Thus, when the first account is lost, the user may recovery the data stored in the first client via the identifying account associating with the first account.

In one alternative embodiment of present disclosure, before the step of the second client receives the identifying account associating with the first account and sends the identifying account to the server, the method may further include the following steps.

The server establishes an associating relationship of the first account and the identifying account. In detail, the step of the server establishes the associating relationship of the first account and the identifying account may include the following steps.

The first client receives the identifying account input by the user and sends the identifying account to the server.

The server receives the identifying account and sends an identifying linkage to the verifying client according to the identifying account. The identify linkage includes an identification of the first account.

The verifying client responses to the connection request of the identifying linkage, and sends an identifying confirming message to the server.

The server receives the identifying confirming message and establishes the associating relationship of the first account and the identifying account.

In another alternative embodiment of present disclosure, after the step of the server establishing an associating relationship of the first account and the identifying account, the method may further include the following steps.

The first client sends an associating storage request to the server. The associating storage request is configured to request for establishing an associating storage of the first account and the data stored in the first client.

The server receives the associating storage request and establishes the associating storage of the first account and the date stored in the first client according to the associating storage request.

In yet another alternative embodiment of present disclosure, after the step of the server receiving the data recovery confirming message and copying the data stored in the first client to the second client according to the data recovery confirming message, the method may further include the following steps.

The server sends the identifying linkage to the verifying client. The identify linkage includes an identification of the second account.

The verifying client responses to the connection request of the identifying linkage, and sends an identifying confirming message to the server.

The server receives the identifying confirming message and establishes an associating relationship of the second account and the identifying account.

In yet another alternative embodiment of present disclosure, after the step of the server receiving the identifying confirming message and establishing an associating relationship of the second account and the identifying account, the method may further include the following steps.

The second client sends an associating storage request to the server. The associating storage request is configured to request for establishing an associating storage of the second account and the data stored in the second client.

The server receives the associating storage request and establishes the associating storage of the second account and the date stored in the second client according to the associating storage request.

When the IM applications serve as the first client and the second client and the e-mail address serve as a verifying client, take recovery contact data of the IM application for example.

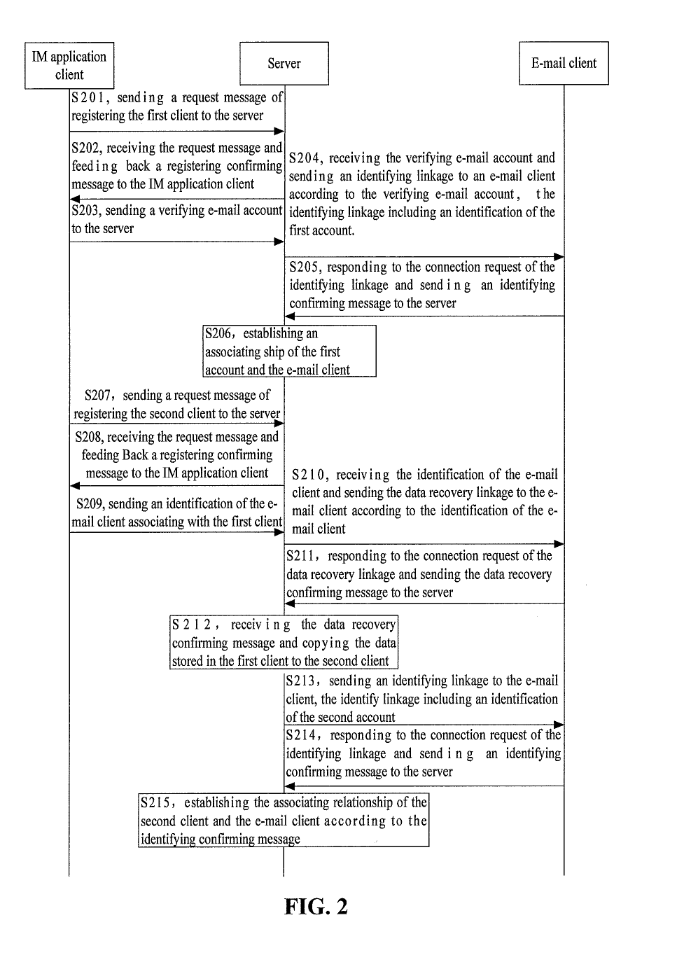

Referring to the FIG. 2, FIG. 2 is a flow chart of a data recovery method according to one embodiment of a detailed application of present disclosure.

Step S201, the user sends a request message of registering a first client to a server via the IM application client.

Step S202, the server receives the request message and feedbacks a registering confirming message to the IM application client.

Step S203, the first client sends a verifying e-mail account to the server.

Step S204, the server receives the verifying e-mail account and sends an identifying linkage to an e-mail client according to the verifying e-mail account. The identifying linkage includes an identification of the first account.

Step S205, the e-mail client responses to the connection request of the identifying linkage and sends an identifying confirming message to the server.

Step S206, the server establishes an associating ship of the first client and the e-mail client.

Step S207, the user sends a request message of registering the second client to the server via the IM application client.

Step S208, the server receives the request message and feeds back a registering confirming message to the IM application client.

Step S209, the second client sends an identification of the e-mail client associating with the first client.

Step S210, the server receives the identification of the e-mail client and sends the data recovery linkage to the e-mail client according to the identification of the e-mail client.

Step S211, the e-mail client responses to the connection request of the data recovery linkage and sends the data recovery confirming message to the server.

Step S212, the server receives the data recovery confirming message and copies the data stored in the first client to the second client.

Step S213, the server sends an identifying linkage to the e-mail client. The identify linkage includes an identification of the second account.

Step S214, the e-mail client responses to the connection request of the identifying linkage and sends an identifying confirming message to the server.

Step S215, the server establishes the associating relationship of the second client and the e-mail client according to the identifying confirming message.

### A Second Embodiment

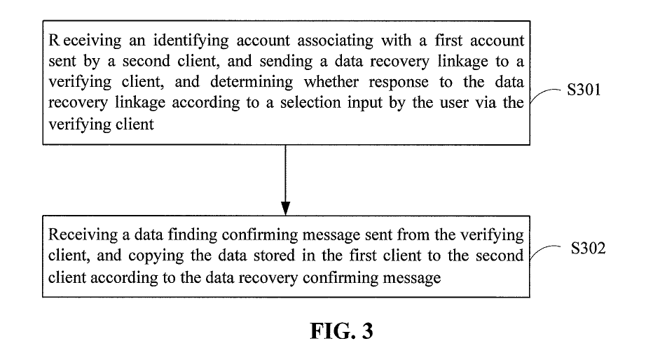

Referring to FIG. 3, FIG. 3 is a flow chart of a data recovery method according another embodiment of present disclosure. The method includes the following steps.

Step S301, receiving an identifying account associating with a first account sent by a second client, and sending a data recovery linkage to a verifying client, and determining whether response to the data recovery linkage according to a selection input by the user via the verifying client. Hereinto, the second client is a client which may be logged in by the user via the second account. The verifying account is a software client which may be logged in by the user via the identifying account. The first account and the second account are accounts registered in a same application.

In the embodiment of present disclosure, when the server receives the identifying account associating with the first account sent by the second client, the server sends the data recovery linkage to the identifying account. When the user logins the identifying account, clicks the data recovery linkage to make sure that the data stored in the first client is copied to the second client.

Step S302, receiving a data recovery confirming message sent from the verifying client, and copying the data stored in the first client to the second client according to the data recovery confirming message. Hereinto, the first client is a client which may be logged in by the user via the first account.

In the embodiment of present disclosure, the data includes address books, videos, documents, audios, pictures and etc. When the server receives the data recovery confirming message fed back from the verifying client, the server copies the data stored in the first client to the second client.

In the embodiment of present disclosure, the second client sends the identify account associating with the first account to the server. The server sends data recovery linkage to the verifying client, the verifying client sends data recovery confirming message to the server, and the server copies the data stored in the first client to the second client. Thus, when the first account is lost, the user may recovery the data stored in the first client via the identifying account associating with the first account.

In one alternative embodiment of present disclosure, before the step of the second client receives the identifying account associating with the first account and sends the identifying account to the server, the method may further include the following steps.

Establishing an associating relationship of the first account and the identifying account. In detail, the step of establishing the associating relationship of the first account and the identifying account may include the following steps.

Receiving the identifying account sent from the first client, sending an identifying linkage to the verifying client according to the identifying account, and determine whether click the identifying linkage according to a selection input by the user via the verifying client. The identifying linkage includes an identification of the first account.

Receiving a data recovery confirming message sent from the verifying client and establishing an associating relationship of the first account and the identifying account.

In yet another alternative embodiment of present disclosure, after the step of establishing an associating relationship of the first account and the identifying account, the method may further include the following steps.

Receiving an associating storage request sent from the first client and establishing an associating storage of the first account and the data stored in the first client according to the associating storage request.

In yet another alternative embodiment of present disclosure, after the step of receiving a data recovery confirming message sent from the verifying client, and copying the data stored in the first client to the second client, the method may further include the following steps.

Sending the identifying linkage to the verifying client, and determining whether click the identifying linkage according to a selection input by the user via the verifying client. The identify linkage includes and identification of the second account.

Receiving an identifying confirming message sent from the verifying client and establishing an associating relationship of the second account and the identifying account according to the identifying confirming message.

In yet another alternative embodiment of present disclosure, after the step of receiving an identifying confirming message sent from the verifying client and establishing an associating relationship of the second account and the identifying account, the method may further include the following steps.

Receiving the associating storage request sent from the second client and establishing the associating storage of the second account and the date stored in the second client according to the associating storage request.

### A Third Embodiment

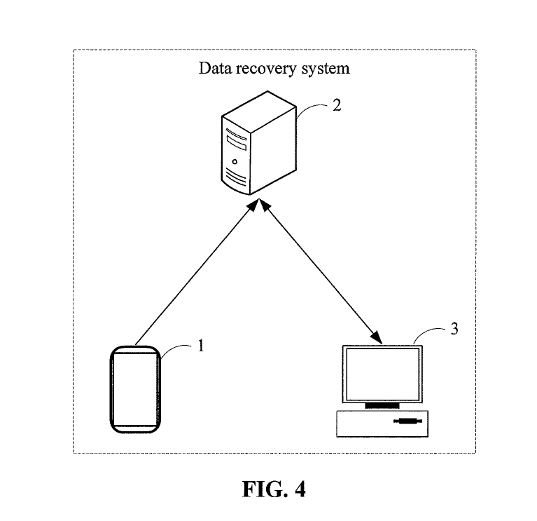

Referring to FIG. 4, FIG. 4 is a schematic block diagram of a data recovery system according to one embodiment of present disclosure. For a convenience purpose, the following description only shows the parts of the data recovery system which is related with the embodiment of present disclosure. The data recovery system includes a second client 1, a server 2 and a verifying client 3.

The second client 1 is configured to receive an identifying account associating with the first account and send the identify account to the server 2. Hereinto, the second client 1 is a client which the user logins via the second account. The first account and the second account are accounts registered in a same application.

The server 2 is configured to receive the identifying account sent from the second client 1, send a data recovery linkage to the verifying client 3, receive a data recovery confirming message sent from the verifying client 3, and copy the data stored in the first client to the second client 1 according to the data recovery confirming message.

The verifying client 3 is configured to response to a connection request of the data recovery linkage sent from the server 2 and send a data recovery confirming message to the server 2.

### A Fourth Embodiment

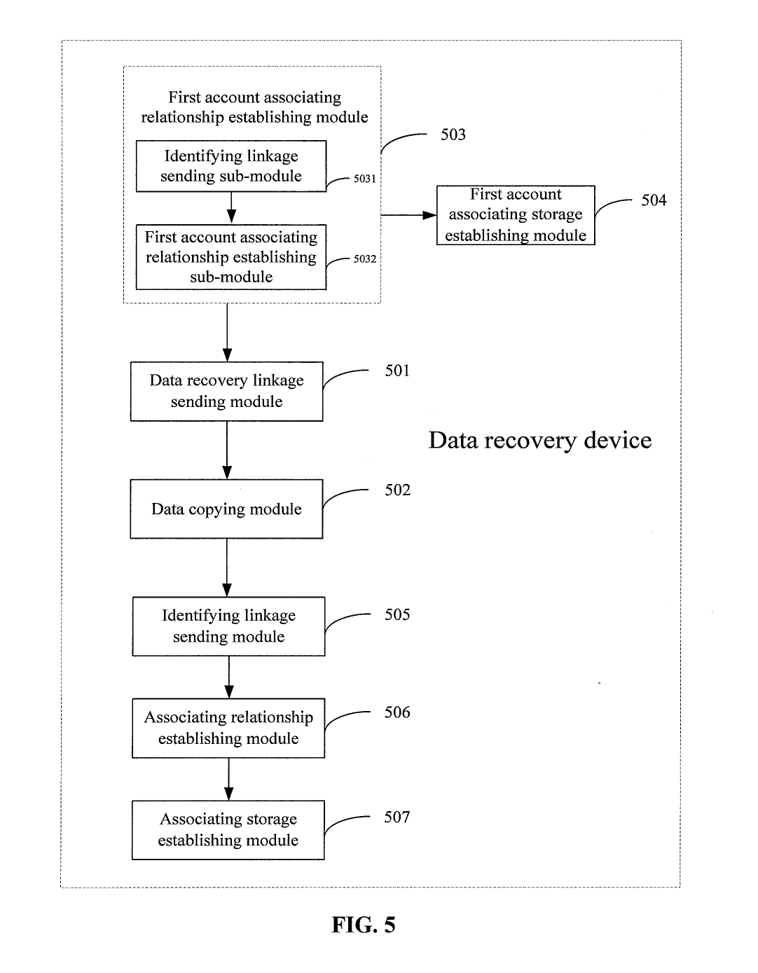

Referring to FIG. 5, FIG. 5 is a schematic block diagram of a data recovery device according to one embodiment of present disclosure. For a convenience purpose, the following description only shows the parte of the data recovery device which is related with the embodiment of present disclosure. The data recovery device includes the following modules.

Data recovery linkage sending module 501, which is configured to receive an identifying account associating with a first account sent by the second client, sending a data recovery linkage to a verifying client, and determining whether response to the data recovery linkage according to a selection input by the user via the verifying client. Hereinto, the second client is a client which may be logged in by the user via the second account. The verifying account is a software client which may be logged in by the user via the identifying account. The first account and the second account are accounts registered in a same application.

In the embodiment of present disclosure, when the server receives the identifying account associating with the first account sent by the second client, the data recovery linkage sending module 501 sends the data recovery linkage to the identifying account. When the user logins the identifying account, clicks the data recovery linkage to make sure that the data stored in the first client is copied to the second client.

Data copying module 502, which is configured to receive a data recovery confirming message sent from the verifying client, and copy the data stored in the first client to the second client according to the data recovery confirming message after the data recovery linkage sending module 501 sending the data recovery linkage. Hereinto, the first client is a client which may be logged in by the user via the first account.

In the embodiment of present disclosure, the data includes address books, videos, documents, audios, pictures and etc. When the server receives the data recovery confirming message fed back from the verifying client, the data copying module 502 copies the data stored in the first client to the second client.

In the embodiment of present disclosure, the second client sends the identify account associating with the first account to the server. The server sends data recovery linkage to the verifying client, the verifying client sends data recovery confirming message to the server, and the server copies the data stored in the first client to the second client. Thus, even if the first account is lost, the user may recovery the data stored in the first client via the identifying account associating with the first account.

In one alternative embodiment of present disclosure, before the data recovery linkage sending module 501 sending the data recovery linkage, the device further includes the following modules.

First account associating relationship establishing module 503, which is configured to establish an associating relationship of the first account and the identifying account. The first account associating relationship establishing module 503 includes the following sub-modules.

Identifying linkage sending sub-module 5031, which is configured to receive the identifying account sent from the first client, send an identifying linkage to the verifying client according to the identifying account, and determining whether click the identifying linkage according to a selection input by the user via the verifying client. The identifying linkage includes an identification of the first account.

First account associating relationship establishing sub-module 5032, which is configured to receive a data recovery confirming message sent from the verifying client and establish an associating relationship of the first account and the identifying account after the identifying linkage sending sub-module 5031 sends the identifying linkage.

In yet another alternative embodiment of present disclosure, after the first account associating relationship establishing sub-module 5032 establishing the associating relationship of the first account and the identifying account, the device further includes the following modules.

First account associating storage establishing module 504, which is configured to receive an associating storage request sent from the first client and establish an associating storage of the first account and the data stored in the first client according to the associating storage request.

In yet another alternative embodiment of present disclosure, after the data copying module 502 copies the data, the device further includes the following modules.

Identifying linkage sending module 505, which is configured to send an identifying linkage to the verifying client, and determining whether click the identifying linkage according to a selection input by the user via the verifying client.

Associating relationship establishing module 506, which is configured to receive an identifying confirming message sent from the verifying client and establish an associating relationship of the second account and the identifying account after the identifying linkage sending module 505 sends the identifying confirming message.

In yet another alternative embodiment of present disclosure, after the associating relationship establishing module 506 establishes the associating relationship of the second account and the identifying account, the device further includes the following modules.

Associating storage establishing module 507, which is configured to receive the associating storage request sent from the second client and establish the associating storage of the second account and the date stored in the second client according to the associating storage request.

To a person of ordinary skill in the art, the modules and sub-modules in the above embodiments are divided in logic function. It is obviously, the division is not limited in the above embodiments, other division that realize the function is also adapted to the present disclosure. Moreover, the names of the modules and sub-modules are only to distinguish from each other, but not to limit to the scope of the present disclosure.

It is also understood to a person of ordinary skill in the art, parts or all of the steps in each method of the above embodiments may be implemented by a hardware which is related to computer programs. The computer programs may be computer instructions stored in the server and the verifying client. In the embodiments, the computer programs may be stored in a computer readable storage medium. Hereinto, the storage medium may be a read-only memory (ROM), a random access memory (RAM), a disk or a compact disk (CD).

Although certain embodiments of the present disclosure have been specifically described, the present disclosure is not to be construed as being limited thereto. Various changes or modifications may be made to the present disclosure without departing from the scope and spirit of the present disclosure.

1. A data recovery method, comprising:
a second client receiving an identifying account associating with a first account and sending the identifying account to a server, the second client being a client which a user logins via a second account, the first account and the second account being accounts registered in the same application;
the server receiving the identifying account and sending a data recovery linkage to a verifying client, the verifying client is a software client which may be logged in by the user via the identifying account;
the verifying client responding to a connection request of the data recovery linkage and sending a data recovery confirming message to the server; and
the server receiving the data recovery confirming message and copying the data stored in the first client to the second client according to the data recovery confirming message, the first client being a client which may be logged in by the user via the first account.

2. The data recovery method according to claim 1, before the step of the second client receiving the identifying account associating with the first account and sending the identifying account to the server, the method further comprising:
the server establishing an associating relationship of the first account and the identifying account; the step of the server establishing an associating relationship of the first account and the identifying account comprising:
the first client receiving the identifying account input by the user and sending the identifying account to the server;
the server receiving the identifying account and sending an identifying linkage to the verifying client according to the identifying account, the identify linkage comprising an identification of the first account;
the verifying client responding to a connection request of the identifying linkage and sending an identifying confirming message to the server; and
the server receiving the identifying confirming message and establishing the associating relationship of the first account and the identifying account.

3. The data recovery method according to claim 1, after the step of the server establishing the associating relationship of the first account and the identifying account, the method further comprising:
the first client sending an associating storage request to the server, the associating storage request configured for establishing an associating storage of the first account and the data stored in the first client; and
the server receiving the associating storage request and establishing the associating storage of the first account and the date stored in the first client according to the associating storage request.

4. The data recovery method according to claim 1, after the step of the server receiving the data recovery confirming message and copying the data stored in the first client to the second client according to the data recovery confirming message, the method further comprising:
the server sending the identifying linkage to the verifying client, the identify linkage comprising an identification of the second account;
the verifying client responding to the connection request of the identifying linkage and sending an identifying confirming message to the server; and
the server receiving the identifying confirming message and establishing an associating relationship of the second account and the identifying account.

5. The data recovery method according to claim 4, after the step of the server receiving the identifying confirming message and establishing the associating relationship of the second account and the identifying account, the method further comprising:
the second client sending the associating storage request to the server, the associating storage request configured for requesting for establishing an associating storage of the second account and the data stored in the second client; and
the server receiving the associating storage request and establishing the associating storage of the second account and the date stored in the second client according to the associating storage request.

6. A data recovery method, comprising:
receiving an identifying account associating with a first account sent by a second client, and sending a data recovery linkage to a verifying client to determine whether response to the data recovery linkage according to a selection of a user via the verifying client, the second client being a client which can be logged in by the user via a second account, the verifying account being a software client which may be logged in by the user via the identifying account, the first account and the second account are accounts registered in the same application; and
receiving a data recovery confirming message sent from the verifying client, and copying the data stored in the first client to the second client according to the data recovery confirming message, the first client being a client which may be logged in by the user via the first account.

7. The data recovery method according to claim 6, before the step of the second client receiving the identifying account associating with the first account and sending the identifying account to the server, the method further comprising:
establishing an associating relationship of the first account and the identifying account, the step of establishing the associating relationship of the first account and the identifying account comprising:
receiving the identifying account sent from the first client, sending an identifying linkage to the verifying client according to the identifying account, and determining whether click the identifying linkage according to a selection input by the user via the verifying client; and
receiving a data recovery confirming message sent from the verifying client and establishing an associating relationship of the first account and the identifying account.

8. The data recovery method according to claim 7, after the step of establishing an associating relationship of the first account and the identifying account, the method further comprising:
receiving an associating storage request sent from the first client and establishing an associating storage of the first account and the data stored in the first client according to the associating storage request.

9. The data recovery method according to claim 8, after the step of receiving a data recovery confirming message sent from the verifying client and copying the data stored in the first client to the second client, the method further comprising:
sending an identifying linkage to the verifying client, and determining whether click the identifying linkage according to a selection input by the user via the verifying client; and
receiving an identifying confirming message sent from the verifying client and establishing an associating relationship of the second account and the identifying account.

10. The data recovery method according to claim 9, after the step of receiving an identifying confirming message sent from the verifying client and establishing an associating relationship of the second account and the identifying account, the method further comprising:
receiving an associating storage request sent from the second client, and establishing an associating storage of the second account and the data stored in the second client.

11. A data recovery device, comprising:
a data recovery linkage sending module, configured for receiving an identifying account associating with a first account sent by a second client, and sending a data recovery linkage to a verifying client to determine whether response to a data recovery linkage according to a selection of a user via the verifying client, the second client is a client which may be logged in by the user via the second account, the verifying client being a software client which may be logged in by the user via the identifying account, the first account and the second account being accounts registered in the same application; and
a data copying module, configured for receiving a data recovery confirming message sent from the verifying client, and copying the data stored in a first client to the second client according to a data recovery confirming message after the data recovery linkage sending module sending the data recovery linkage, the first client being a client which may be logged in by the user via the first account.

12. The data recovery device according to claim 11, before the data recovery linkage sending module sending the data recovery linkage, the device further comprising:
a first account associating relationship establishing module, configured for establishing an associating relationship of the first account and the identifying account; the first account associating relationship establishing module comprising:
an identifying linkage sending sub-module, configured for receiving the identifying account sent from the first client, sending an identifying linkage to the verifying client according to the identifying account, and determining whether click the identifying linkage according to a selection input by the user via the verifying client; and
a first account associating relationship establishing sub-module, configured for receiving a data recovery confirming message sent from the verifying client and establishing an associating relationship of the first account and the identifying account after the identifying linkage sending sub-module sending the identifying linkage.

13. The data recovery device according to claim 12, after the first account associating relationship establishing sub-module establishing the associating relationship of the first account and the identifying account, the device further comprising:
a first account associating storage establishing module, configured for receiving an associating storage request sent from the first client and establishing an associating storage of the first account and the data stored in the first client according to the associating storage request.

14. The data recovery device according to claim 13, after the data copying module copying the data, the device further comprising:
an identifying linkage sending module, configured for sending an identifying linkage to the verifying client, and determining whether click the identifying linkage according to a selection input by the user via the verifying client; and
an associating relationship establishing module, configured for receiving an identifying confirming message sent from the verifying client and establishing an associating relationship of the second account and the identifying account after the identifying linkage sending module sending the identifying confirming message.

15. The data recovery device according to claim 14, after the associating relationship establishing module establishing the associating relationship of the second account and the identifying account, the device further comprising:
an associating storage establishing module, configured for receiving the associating storage request sent from the second client and establishing the associating storage of the second account and the date stored in the second client according to the associating storage request.

16. (canceled)
